(19) United States
(12) Patent Application Publication
(10) Pub. No.: US 2022/0312868 A1
(43) Pub. Date: Oct. 6, 2022

(54) Transfigurable Face Mask

(71) Applicant: Suzanne Holliday, Dover, FL (US)

(72) Inventor: Suzanne Holliday, Dover, FL (US)

(21) Appl. No.: 17/301,525

(22) Filed: Apr. 6, 2021

(51) Int. Cl. A41D 13/11; A62B 18/02; A62B 18/08; A62B 7/10; A62B 23/02

(52) U.S. Cl. CPC A41D 13/1161; A62B 18/025; A62B 18/084; A62B 7/10; A62B 23/025

(57) ABSTRACT

A transfigurable trapezoid-shaped face mask comprised of cloth-like material, the top end of which fits over the nose and across the face to the helix of each ear of a wearer, its length extends past the face of a wearer, and its bottom end is wide enough to be secured at the back base of the neck of a wearer. The face mask can be converted and transitioned easily between several different positions and has a securing mechanism that is worn over a wearer's ear and secured at the back of the head.

### FIELD OF THE INVENTION

This invention relates to face masks.

### BACKGROUND and PRIOR ART

The following is a tabulation of some prior art that presently appears relevant:

### U.S. Patents

| Patent Number | Kind Code | Issue Date | Patentee |
|---|---|---|---|
| 10,835,704 | B1 | Nov. 17, 2020 | Heimbuch et al. |
| 10,808,338 | B1 | Oct. 20, 2020 | Yidi |
| 10,357,672 | B2 | Jul. 23, 2019 | Bora |
| 9,763,482 | B2 | Sep. 19, 2017 | Carcich et al. |
| D723,245 | S | Mar. 3, 2015 | Womack |
| 7,096,511 | B2 | Aug. 29, 2006 | Cohen |
| 6,855,410 | B2 | Feb. 15, 2005 | Buckley |
| 6,474,336 | B1 | Nov. 5, 2002 | Wolfe |
| 5,701,892 | A | Dec. 30, 1997 | Bledstein |
| 4,384,577 | | May 24, 1983 | Huber et al. |
| 4,195,629 | | Apr. 1, 1980 | Halford |
| 3,699,958 | | Oct. 24, 1972 | Szucs |
| 3,101,709 | | Aug. 27, 1963 | Gruenewaelder |
| 1,502,450 | | Jul. 22, 1924 | Wood |

### U.S. Patent Application Publications

| Publication Nr. | Kind Code | Publication Date | Applicant |
|---|---|---|---|
| 20170371177 | A1 | Dec. 28, 2017 | Yribarren |
| 20140224261 | A1 | Aug. 14, 2014 | Tsuei |
| CA2424898C | A4/1D | Jun. 29, 2010 | Tredup |
| 20060143796 | A1 | Jul. 6, 2006 | Bugarin |

### Foreign Patent Documents

| Foreign Doc. Nr. | Country Code | Kind Code | Pub. Dt |
|---|---|---|---|
| 2018180414 | WO | A1 | Oct. 4, 2018 |
| 2017020497 | WO | A1 | Feb. 9, 2017 |
| 104188186 | CN | A | Dec. 10, 2014 |
| 2014155876 | JP | A | Aug. 28, 2014 |
| 2013220301 | JP | A | Oct. 28, 2013 |
| 102100417 | CN | A | Jun. 22, 2011 |
| 2010051388 | JP | A | Mar. 11, 2010 |
| 3126242U | JP | A | Oct. 19, 2006 |

By the later 20th and early 21st centuries, the use of medical and industrial grade face masks by the general population, to avoid infectious airborne agents as well as pollutants, had become common in densely populated and heavily polluted urban areas outside of the United states. Several improvements to these medical and industrial grade face masks such as those provided by inventions in granted patents and patent publications had increased both the efficacy of mask fibers and their construction, rendering their designs more conducive to limited short term daily wear, and thereby contributing to the appeal and marketability of these masks. With the exception of a few geographic areas, this mask wearing practice did not extend to the general populace of the United States until the onset of the Novel Coronavirus 19 in early 2020. A growing concern by the populace of the United States regarding the spreading pandemic, as well as widespread mandates requiring face coverings instituted by governmental agencies, and by the owners of many private enterprises, increased the demand for these masks and threatened to exceed their supply. Additionally, a wide acceptance of the theory that masks that are constructed of materials other than those used in the manufacturing of medical and industrial grade masks are still effective in reducing the exposure to and spread of the Novel Coronavirus 19, resulted in the production of face masks that were based upon these designs but were instead constructed with textiles and materials generally used in the manufacture of apparel. These fabric face masks utilized the same common rectangular shape of the disposable surgical mask style and employed the ear loop design to keep the mask in place on the face of a wearer, whereby a strap is attached to the upper and lower corners of both the right and left sides of the mask body and looped around the ear of the wearer. The body of these masks either utilized the folded, pleated, plain, or dual chambered designs. Other fabric face coverings that had been utilized for thermal control such as neck gaiters also began to be utilized as well. This acceptance of the efficacy of face masks constructed of these materials also gave these masks the added advantage of being washable and reusable, a very worthy advantage in consideration of the environmental impact of the unprecedented number of people who now needed to wear face masks daily in all social and work settings.

One of the other most common mask types being utilized, the CN102100417A, 6/22/11, N95 type negative Ion mask filtration system, also employed the traditional rectangular mask shape and ear loop system. In addition to this mask and those listed above, several other mask and face covering styles were utilized, revived, repurposed, or created to attempt to meet this new face mask need. One such style utilized the same body style of the pleated, folded, and flat masks of the surgical masks above, but instead of the ear loop system of maintaining mask placement, it revived the tie strap system pictured in U.S. Pat. No. 3,101,709, Aug. 27, 1963, wherein a strap is affixed to each of the four corners of the mask and are tied behind the upper and lower portion of a wearer's head. An additional variation of the ear loop system is also shown in U.S. Pat. No. 4,195,629, Apr. 1, 1980, and in U.S. publication number 20140224261, 8/14/14, wherein the mask has a section cut out of it for which to fit around the wearer's ear. In addition to these masks, individuals also utilized bandanas by either utilizing the fabric of the body of the bandana to tie them around their head or by adding and employing the traditional face mask ear loop system. Scarves attached to the traditional masks that are comprised of a rectangular shaped body and employ the ear loop system were also utilized as one of the new face covering styles. Plastic face shields have also been marketed and utilized.

However, since the current requirements for and the characteristics of a mask wearing member of the general populace during a period of time that necessitates mask wearing for prolonged periods of time and across many different social and work settings differ from that of an individual working in isolated medical or industrial environments, the extant mask and face covering inventions and variations, heretofore known, suffer from a number of disadvantages either with regards to the materials with which they are constructed, their design, or both.

The first major disadvantage with the majority of face masks currently being designed for or utilized by the general population is that their designs remain based on those of the medical or industrial models and the differing criteria and the motivation of the current mask wearing general population renders these designs unnecessary and presents numerous obstacles to the adherence of proper mask wearing for many mask wearers.

Firstly, the ear loop system, whether in the form of a strap system or a portion cut out of the rectangular mask body for the ear to fit through has been found to be uncomfortable and, therefore, a deterrent to mask wearing for a large number of individuals, especially in consideration of the unprecedented scope of mask wearing mandates with regard to how long, how often, and in the many different environments this mask wearing practice is required. Extensions that utilize additional straps and additional mechanisms such as lobster claw clasps, buttons, hook and loop bands, toggles and ties that attach to the ear loop to ease this discomfort that the ear loop strap causes to the wearer's ear have been utilized but these additions have their own drawbacks with regards to additional expense and the added inconvenience of having to employ another device along with the mask. Toggles have also been added to make the ear loop adjustable, and therefore ease some of this discomfort, but it only serves to alleviate this discomfort minimally and has the additional disadvantage of rendering the mask loose enough for the wearer to wear the mask incorrectly under the nose thereby rendering the mask ineffective as a vehicle for protection.

Secondly, the two-strap system whereby one strap is tied over the ears to the top of a hat on a wearer's head or at the back of a wearer's head and the other strap is tied under the chin and behind the lower head of the wearer, while alleviating the ear discomfort for some, is uncomfortable when the bottom strap is employed causing the fabric to rest uncomfortably under the chin and against the throat of a wearer and leads to improper mask wearing as the bottom strap is frequently left untied. Additionally, the Diop mask employs this two-strap system but, instead of being secured by tying, it is secured by toggle clasps. This mask, however, has the same under chin comfort issues and they both have breathability issues as well.

Thirdly, regardless of whether or not the design is flat or pleated, the rectangular shape of this mask when made of textiles poses the additional problem of causing fogging when worn in conjunction with eyeglasses. Adaptations that assist with overcoming this exist but are cumbersome or expensive and are generally not adaptative to textiles.

The multipurpose face mask that maintains airspace, U.S. Pat. No. 5,701,892, Dec. 30, 1997, combats this fogging issue well but has the added disadvantage of being maladaptive to many face shapes leading to the mask being worn under the nose by many. Different sizes are beginning to be marketed but thus far have not proven to solve this problem and this mask's shape, in combination with the ear loop system, continues to promote improper mask wearing. Alternatively, the wearing of neck gaiters or neck sleeves as a face covering combats this eye fogging issue somewhat but because it is tight fitting and un-wielding by design, it is found to be uncomfortable by many and this style also does not function well with many hairstyles. In contrast, the wearing of bandanas addresses the issue of discomfort arising from a tight-fitting design but both of the securing mechanism designs it utilizes, the ear loop design and the simple tie back design, have their own disadvantages: the discomfort of the ear loop system and the tendency of the material to slip down below the nose of the wearer when tied behind the wearer's head. In addition, the efficacy of both the neck gaiter and bandanas have been challenged. The plastic face shield has also had some success with combating eye fogging but the band that holds it in place on the wearer's head is uncomfortable for many wearers. This type of face covering also has the added disadvantage in that because it is constructed of plastic and therefore less porous, germs survive on its surface longer and, additionally, the efficacy of this design with regards to protection from viral exposure has also been questioned.

In addition to these face masks and coverings, clothing with built in mask systems have also been created and marketed but have met with poor results due to comfort, style, and the cumbersome commitment necessitated in the utilization of these items. Masks termed “open-holed” that are purely decorative and designed without a protective layer, textile or otherwise, have also met with some commercial success, further illustrating the various motives for mask wearing.

### SUMMARY

In accordance with one embodiment, a face mask comprises a trapezoid shaped body comprised of cloth-like material. The top narrow parallel end of the face mask body extends over the nose and across the face to the helix of each ear of a wearer and has straps affixed to its top two exterior corners. Said straps have a securing mechanism to secure said face mask at the back of the head of a wearer at the occipital bone and the low wide parallel end of the mask body has mechanisms for securing both of its lower corners behind the back base of the neck of a wearer. In accordance with this embodiment, the securing mechanisms allow the wearer to either employ both the top and the bottom securing mechanisms for ultimate mask protection, employ only the top securing mechanism to allow the mask to hang loosely over and across a wearers face and down to the collar bones of a wearer while still providing protection because of its shape, multiple layers, and fabric envelope, or instead choose to loosen the securing mechanism so that the mask rests in a scarf like position around the neck and on the shoulders of a wearer for easy reutilization of the mask's protective feature. Unexpectedly, the elements of said mask combine to negate the tendency for either improper or ineffective mask wearing when its securing devices are employed in its protective state. The elements of the mask combine to necessitate that the mask must be worn either fully engaged with the top mechanism, regardless of whether or not the bottom mechanism is engaged, or fully at rest around a wearer's neck. This device will become more fully understood from the detailed description and the accompanying drawings.

### Advantages

Accordingly, several advantages of one or more aspects are as follows: to provide members of the general public with a protective and reusable face mask that is safer, more comfortable, looks more attractive, has a tendency to fog less, fits all variety of face shapes, and alleviates mask slippage, thereby promoting adherence to effective mask wearing. Other advantages of one or more aspects will be apparent from a consideration of the drawings and ensuing description. It should be understood that the detailed description and specific examples, while indicating the preferred embodiment of the invention, are intended for the purposes of illustration only and are not Intended to limit the scope of the invention.

### DRAWINGS and FIGURES

The present device will become more fully understood from the detailed description and the accompanying drawings. The drawings constitute a part of this specification and exemplary embodiments of the device, which may be embodied in various forms. It is to be understood that the drawings are exemplary in nature and are, in no way, intended to limit the invention. In some instances, various aspects or elements of the device may be shown exaggerated or enlarged to facilitate an understanding of the device and, therefore, the drawings are not necessarily to scale. In the drawings, closely related figures have the same number but different alphabetic suffixes.

FIGS. 1A, 1B, and 1C show the front, side, and rear views of the first embodiment of the device being worn by a wearer with both the top and bottom securing mechanisms engaged.

FIG. 1D shows the side view of the first embodiment of the device being worn by a wearer with both securing mechanisms engaged but being worn as a scarf instead with the protection aspect of the device not employed.

FIGS. 2A, 2B, and 2C show the front, side, and rear views of the first embodiment of the device being worn by a wearer with only the top mechanism of the device being employed but said device still providing some protection.

FIGS. 3, 4, 5, and 6 show the rear view of different combinations of the elements of additional embodiments of the device being worn by a wearer with both the top and bottom securing mechanisms engaged.

FIG. 7 shows the interior view of the second embodiment.

FIG. 8 shows the interior view of the third embodiment.

FIGS. 9 and 10 show the interior view of alternate embodiments of the device.

FIG. 11 shows the interior view of the first embodiment of the device.

FIG. 12 shows the exterior view of the first embodiment of the device with the interior and exterior mask layers attached to one another.

FIGS. 13 and 14 show the interior view of alternate embodiments of the device with decorative embellishments.

FIG. 15 shows the interior view of the first embodiment of the device and the elements of the fabric envelope.

### DETAILED DESCRIPTIONS

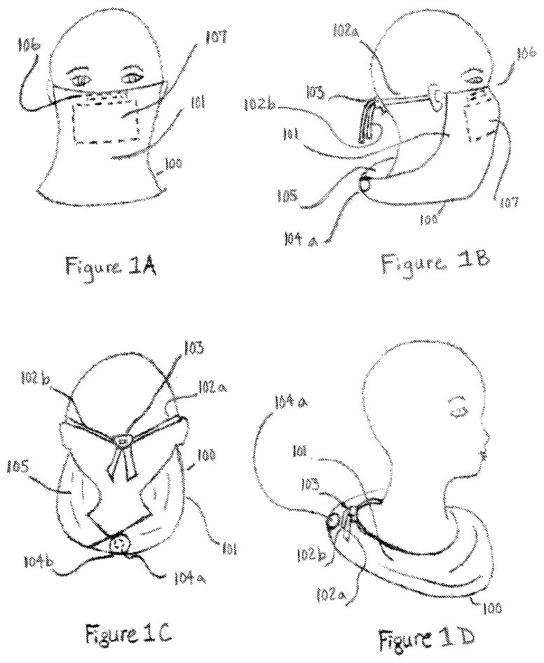

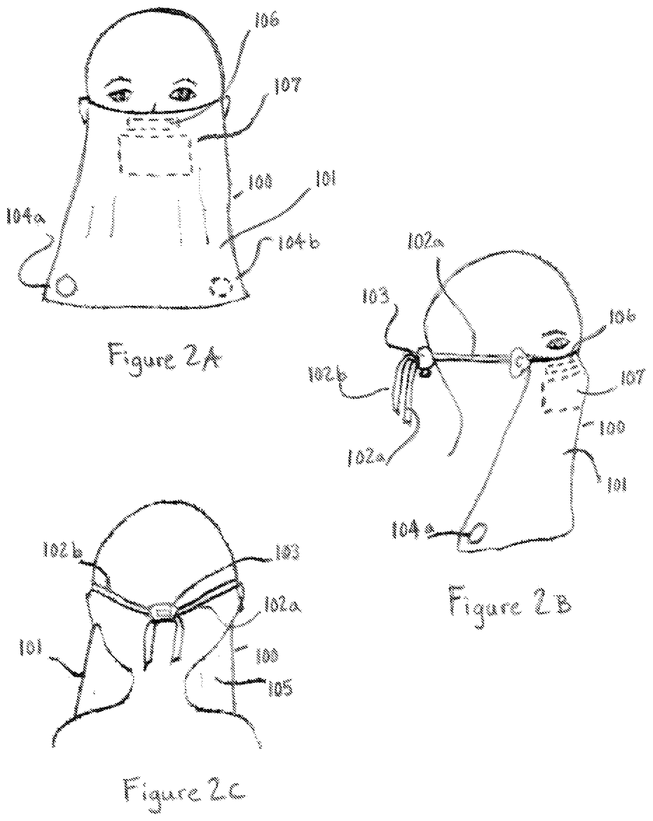

FIG. 12 is the exterior front view of a first exemplary embodiment of a transfigurable face mask 100 that has an exterior layer 101 comprised of a trapezoid shape. It has a top 1201, a bottom 1202, and two identical matching parallel sides 1203a and 1203b. The top 1201 of the face mask 100 measures approximately 26 centimeters or of a sufficient width to be positioned over the nose of a wearer and for each corner of the face mask top 1201 to extend to and from the helix of each ear of a wearer. The bottom 1202 of the face mask 100 measures approximately 55 centimeters or of a sufficient width to reach around the neck of a wearer when secured. The parallel sides 1203a and 1203b of the face mask 100 are identical and measure approximately 19 centimeters in length or of a sufficient length to extend from the helix of a wearer's ear down past a wearer's chin and to approximately the collarbones of a wearer for the purpose of aesthetics and optimum protection for droplet deflection or absorption when the top 1201 of the face mask is engaged in its protective mode. This utilization of the protective mode of the face mask 100 protective will become more apparent in the detailed description of FIGS. 1A-1D. In this embodiment, the exterior layer 101 of said mask 100 is comprised of a cotton, lycra, polyester blend to allow for a layer of protection that promotes fashionable wearability due to its lightweight and flexible qualities but the mask 100 exterior 101 may also be comprised of any other cloth like material.

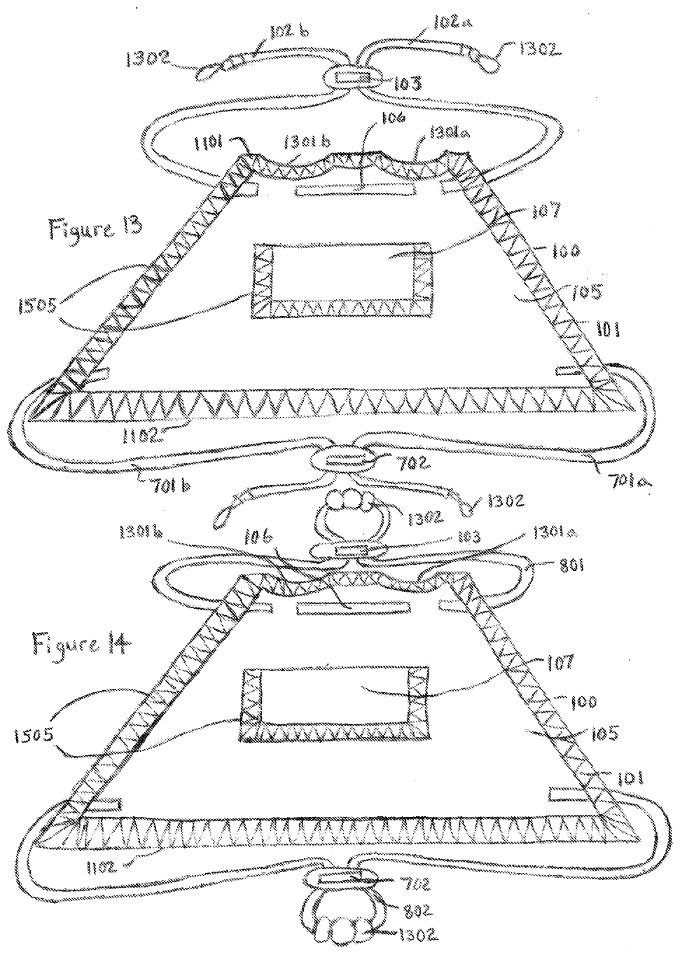

FIG. 11 is the interior view of a first exemplary embodiment of a transfigurable face mask 100 that is comprised of an interior mask layer 105 that is comprised of a trapezoid shape and shares the identical measurements of the exterior mask layer 101. The top 1101 of the interior layer 1101 measures approximately 26 centimeters, the bottom of the mask interior 1102 measures approximately 55 centimeters, and the identical parallel sides 1103a and 1103b of the mask 100 measure approximately 19 centimeters in length. The interior mask body 105 of this embodiment is comprised of a cotton sateen for its protective qualities due to its tight weave but the mask interior 101 may also be comprised of any other cloth-like material. In this embodiment the interior mask layer 105 has two identical straps 102a and 102b, measuring approximately 48 centimeters each, or of an appropriate length to accommodate the wearing of the face mask 100 while engaged in either the protective or at ease modes of the face mask 100. The straps 102a and 102b in this embodiment are comprised of elastic cording but may, alternatively, be comprised of paracord, stretch binding, strips of knitted fabric or any other suitable materials that are comfortable to a wearer while fitted over the ear and secured at the back of a wearer's head. The straps 102a and 102b are affixed to the corners of the top 1101 of the face mask 100 by traditional stitching 1504 but may also be affixed with a Serger overlocking stitch 1505 or by any other secure means. In this embodiment, the straps 102a and 102b are threaded through a toggle device 103 as the means for securing the top 1101 of the face mask 100 at the back of a wearer's head. In this embodiment, the toggle clamp device is comprised of springs, an elongated round body and two holes, but the toggle clasp device may also be single-holed, un-sprung, or of any other appropriate shape that allows for the necessary tension that is achieved when combined with the straps 102a and 102b. In this embodiment, a pair of snaps 104a and 104b are affixed to each corner of the face mask bottom 1102 as the means for securing the bottom 1102 of the face mask behind the neck of a wearer 100. In this embodiment, the interior face mask layer 105 is also comprised of a flexible metallic-like nose bridge 106 to aid in proper face mask placement and comfort. In this embodiment, the nose bridge 106 measures approximately 9 centimeters and is affixed in the center of and, approximately 0.5 centimeters from, the top of the interior layer 105 of the face mask 100, with “Liquid Fusion” but may also be affixed with any other universal bonding adhesive. In this embodiment, the interior face mask is also comprised of a fabric envelope 107 to allow for a HEPA filter insertion.

FIG. 15 shows the interior of a first exemplary embodiment of a transfigurable face mask 100 and the elements of the fabric envelope 107. In this embodiment, the fabric envelope 107 is comprised of the same fabric as the interior mask layer 105 but may, alternatively, be comprised of any cloth like material. In this embodiment, the fabric envelope is rectangular in shape, w/ a top 1501, bottom 1502, and sides 1503a and 1503b. The top 1501 and bottom 1502 of the fabric envelope 107 each measure approximately 5.5″. The sides 1503a and 1503b of the fabric envelope 107 each measure approximately 3.15″ or, alternately, of appropriate dimensions to allow for the insertion of a HEPA filter that is of a sufficient size to concurrently cover the nose and mouth area of a mask wearer. In this embodiment, the fabric envelope 107 is affixed horizontally to the interior side of the interior mask layer 105 at approximately 1.5 centimeters from the interior mask top 1101 but may, alternatively, be placed vertically at a sufficient location to serve as protection to and from the nose and mouth of a mask wearer. In this embodiment, the fabric envelope 107 is attached to the face mask interior 105 by a Serger overlock stitch 1505, but may also be attached by traditional stitching, adhesive, or any other secure method. The top 1501 of the fabric envelope 107 is left unattached to the interior mask layer 105 to allow for easy HEPA filter insertion by a mask wearer but may also, alternatively, be affixed to allow for the insertion of a HEPA filter at either side 1503a or 1503b of the fabric envelope 107.

In a first exemplary embodiment of a transfigurable face mask 100 in FIG. 12, the interior mask layer 105 and the exterior mask layer 101 of the face mask 100 are connected by a Serger overlock stitch 1505, but may also be connected together by a traditional stitch, adhesive, or any other method that promotes a close fabric connection for optimum wearer protection. The new combination of an exterior mask layer 101, an interior mask layer 105, and an additional fabric envelope layer 107 with a HEPA filter results in a new four-layer mask that provides a mask wearer with the newly prescribed protection of a two-mask system, commonly recommended by authorities, in the convenient form of a single mask.

FIGS. 1A, 1B, and 1C are the front, side, and rear view of a first exemplary embodiment of a transfigurable face mask 100, being worn by a wearer with both the top 102a, 102b, and 103 securing mechanisms and bottom securing mechanisms 104a and 104b engaged. It also includes an exterior mask body layer 101, an interior mask body layer 105, a right top strap 102a, a left top strap 102b, a toggle securing mechanism 103 into which both top straps 102a and 102b are inserted, a nose bridge 106, a fabric envelope for HEPA filter insertion 107, and a pair of interlocking snaps 104a and 104b attached to the lower corners of the interior mask body 105. The interior 105 and the exterior 101 of said mask 100 are comprised of a trapezoid shape and in this embodiment the interior 105 is comprised of a cotton sateen for its protection due to its tightly woven qualities and the exterior 101 is comprised of a cotton, lycra, polyester blend for an additional layer of comfort that is light weight, flexible, and allows for a decorative quality to promote fashionable wearability but may, alternatively, be comprised of any suitable cloth-like material. The top width of the mask bodies 101 and 105 measures approximately 26 centimeters or of a sufficient width to extend from the helix of each ear of a wearer. The bottom width of the mask bodies 101 and 105 measures approximately 55 centimeters or to be of a sufficient width to reach around the bottom of the neck of the wearer and enable it to be secured comfortably at the shoulders of a wearer by a pair of snaps 104a and 104b. The interior 105 and the exterior 101 mask bodies in this embodiment are attached to each other by a Serger overlocking stitch 1505 but may also be attached by a traditional stitching method, fabric adhesive, or any other manner that promotes a close fabric connection for optimum wearer protection. The length of the interior mask body 105 and the exterior mask body 101 measure approximately 19 centimeters or of a sufficient length to extend past a wearer's chin to approximately the collar bones of a wearer for the purposes of aesthetics and optimum protection from droplet deflection or absorption. The top right strap 102a and the top left strap 102b of this embodiment are comprised of elastic cording, but may alternately be comprised of paracord, stretch binding, strips of fabric or any other suitable materials that are comfortable to a wearer while fitted over the top of the ear and secured with appropriate tension at the back of a wearer's head and are secured by a toggle device 103 at the top of the occipital bone of a wearer.

FIG. 1D shows the view of the first exemplary embodiment of a transfigurable face mask worn by a wearer as a scarf. Unexpectedly, the tension from the strap cording 102a and 102b when inserted into and secured by the toggle device at the top of the occipital bone of the wearer results in an optimal tension that keeps the mask device 100 in place but when the toggle 103 is relaxed even slightly the result is that the mask must be worn in the “at rest” scarf position of FIG. 1D. This further ensures that the face mask 100 must either be worn in a position of protection or in a position of obvious deployment which alleviates the issue of improper incidental under the nose mask wearing. In addition, the ease with which a mask wearer can adjust and transform the mask from protection to scarf and also from scarf to protection makes correct face mask wearing more convenient to a wearer and, therefore, more likely.

FIGS. 2A, 2B, and 2C are the front, side, and rear view of a first exemplary embodiment of a transfigurable face mask 100 being worn by a wearer with only the top securing mechanisms of the device, the straps 102a and 102b and toggle clasp 103, being deployed. The dimensions and elements of FIGS. 2A-2C are identical to those in FIGS. 1A-1D. FIGS. 2A, 2B, and 2C illustrate the protection that is provided from the face mask 100 to a wearer when only the top securing mechanism is deployed. When worn in this position, the face mask has the added advantage of increased breathability, comfort, and reduced fogging for a mask wearer wearing eyeglasses. In addition, the securing mechanism 104a and 104b can easily be re-engaged by a wearer as needed.

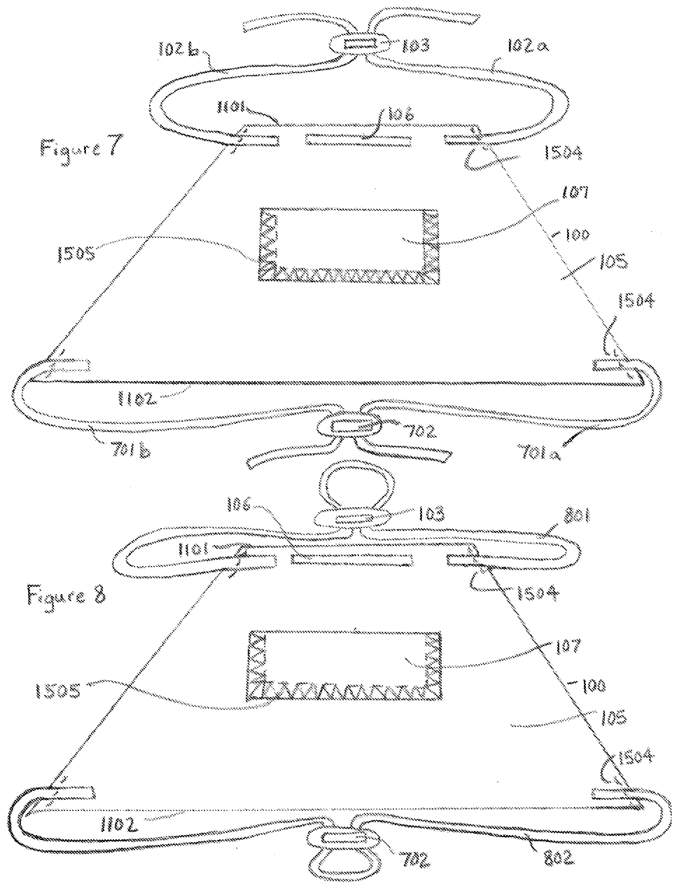

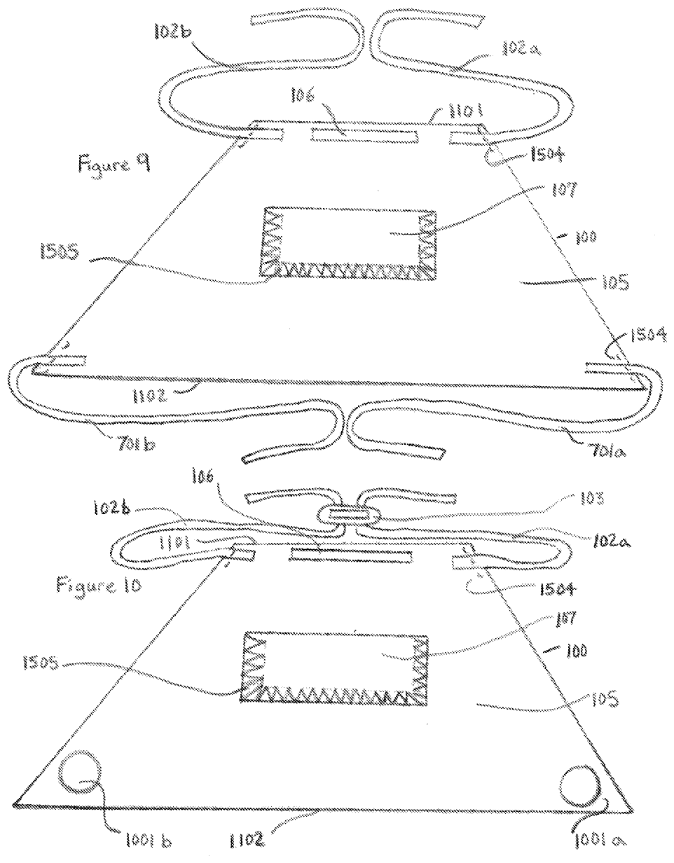

FIG. 7 shows the interior view of a second exemplary embodiment of a transfigurable face mask 100. In this embodiment, the securing mechanism of the interior face mask top 1101 is comprised of a pair of straps 102a and 102b and a toggle clasp device 103 that may be tightened behind the head at the occipital bone of the wearer as seen in FIGS. 1A, 1B, and 1C or relaxed to be worn around the neck of the wearer as in FIG. 1D. The securing mechanism of the interior face mask bottom 1102 is also comprised of a pair of straps 701a and 701b. Each strap 701a and 701b is affixed to the corners of the interior face mask bottom 1102 by traditional stitching 1504 and threaded through a toggle clasp device 702. The toggle clasp device 702 may be used alternatively to tighten the straps so that the bottom of the mask may be secured at the back base of a wearer's neck as in FIGS. 1A, 1B, and 1C, or kept secure to be worn in the scarf mode of FIG. 1D, or loosened to be worn as in FIGS. 2A, 2B, and 2C. In this embodiment, said straps 701a and 701b each measure approximately 34 centimeters but may be of a sufficient length that allows the face mask to be either secured at the base of a wearer's neck or worn loosely.

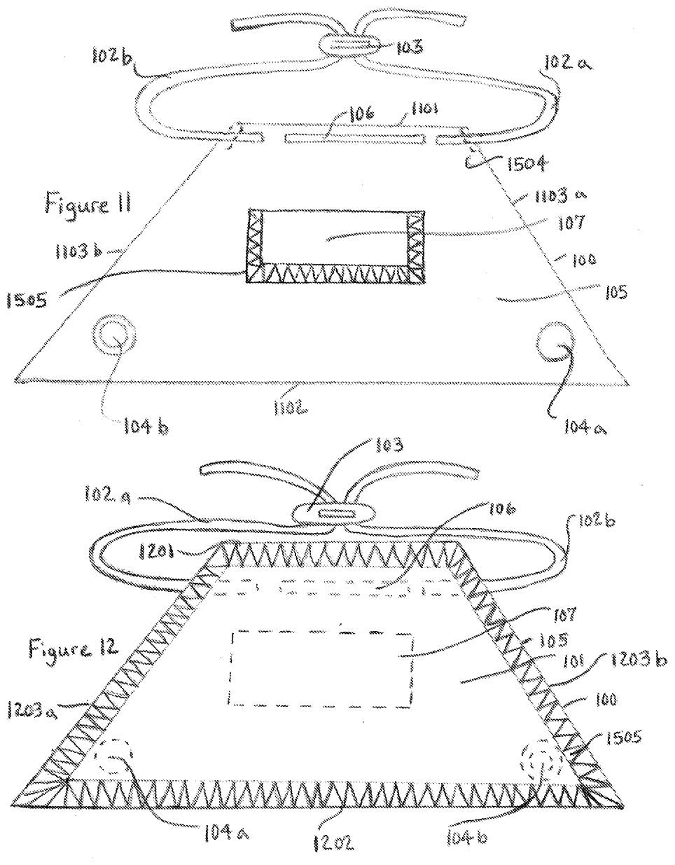

FIG. 8 shows the interior view of a third exemplary embodiment of a transfigurable face mask 100. In this embodiment, the top securing mechanism is comprised of a continuous, single strap 801 that is affixed to each corner of the interior face mask top 1101 and threaded through a toggle clasp device 103. The single strap 801 measures approximately 30 centimeters or of a sufficient length to be employed securely at the back of a wearer's head or at the base of a wearer's neck as a scarf. In this embodiment, the bottom securing mechanism is also comprised of a continuous, single strap 802 that is affixed to each corner of the interior face mask bottom 1102 and threaded through a toggle clasp device 702. In this embodiment, said single strap 802 measures approximately 55 centimeters or of a sufficient length to secure the bottom of said face mask around the back base of a wearer's neck or to allow it to be worn loosely around a wearer's face. The toggle clamp device 702 shown is comprised of a double-holed, rounded body but the toggle device may also be single-holed, un-sprung, or of any other appropriate shape that allows for the necessary tension that is achieved when combined with said strap 802.

FIG. 9 shows the interior view of an additional exemplary embodiment of a transfigurable face mask 100. In this embodiment, the top and bottom securing mechanisms shown are comprised of a top pair of straps 102a and 102b to be tied by and secured by a wearer behind a wearer's head or tied loosely to be worn as a scarf and a pair of bottom straps 701a and 701b to be tied by a wearer behind the base of a wearer's neck or tied loosely to be worn as seen in FIGS. 2A, 2B, and 2C. The combination of the new mask shape combined with the intended placement of the tied strap at the occipital bone of a wearer and the comfortable placement of the bottom tie at the back base of a wearer's neck provides the new unexpected result present in the previous and additional exemplary embodiments: these aspects and elements combine to necessitate that the mask must be worn fully engaged while the top mechanism is engaged or fully at rest around a wearer's neck. This serves to negate the tendency of ineffectively wearing said face mask under a wearer's nose.

FIG. 10 shows the interior view of an additional exemplary embodiment of a transfigurable face mask 100. In this embodiment the top securing mechanism is a pair of straps 102a and 102b and a toggle clasp 103. The bottom securing mechanism is a pair of magnets 1001a and 1001b that are affixed to each of the bottom interior mask 1102 corners. In this embodiment, the pair of magnets 1001a and 1001b are circular and each measure approximately 0.5″ across, but may be of any size or shape that provides a secure attachment of the face mask behind the base of a wearer's neck. In this embodiment, the magnets 1001a and 1001b are affixed by a universal adhesive but may alternately be affixed by any secure method.

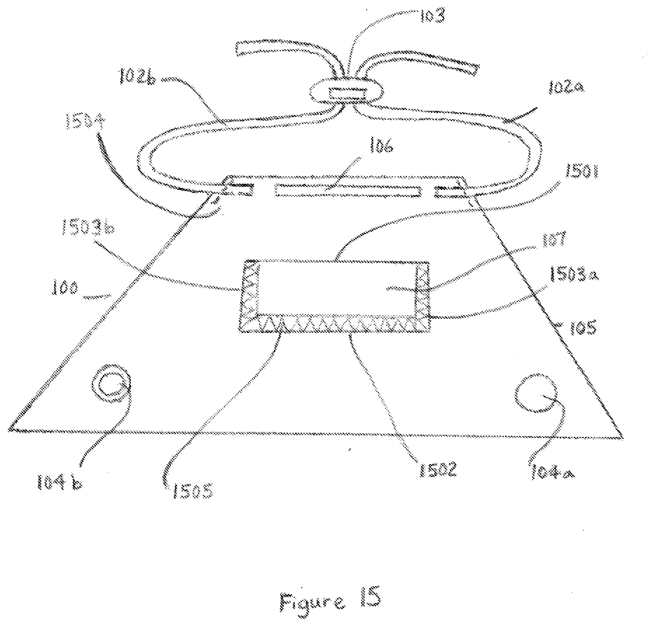

FIG. 13 shows the interior view of an additional exemplary embodiment of a transfigurable face mask 100 with the interior face mask layer 105 and the exterior face mask layer 101 attached. The face mask 100 is comprised of the securing mechanisms of the second embodiment but with the addition of beaded embellishments 1302 at the end of the top straps 102a and 102b and at the end of the bottom straps 701a and 701b. Alternatively, charms or any other decorative element may be utilized as ornamentation. In addition, this embodiment is also comprised of oval-shaped indents 1301a and 1301b at the mask top 1101 to promote optimal comfort of the lower eyes for a mask wearer. In this embodiment, the deepest point of said indent 1301 measures approximately 1 centimeter and the slope of the indent begins at approximately 6 centimeters from each corner of the interior top mask 1101 and exterior top mask 1201 and ends approximately 11 centimeters from each corner. Alternatively, the size and shape of these indentations may be altered to accommodate different face sizes.

FIG. 14 shows the interior view of an additional exemplary embodiment of a transfigurable face mask 100. In this embodiment, the exterior mask layer 101 and interior mask layer 105 are attached. The face mask 100 is comprised of the securing mechanisms of the third embodiment and with the addition of beaded embellishments 1302 in the center of straps 801 and 802. Additionally, charms or any other ornamentation may be affixed to the center of the strap. The face mask is also comprised of indents 1301a and 1301b to provide additional comfort to a mask wearer.

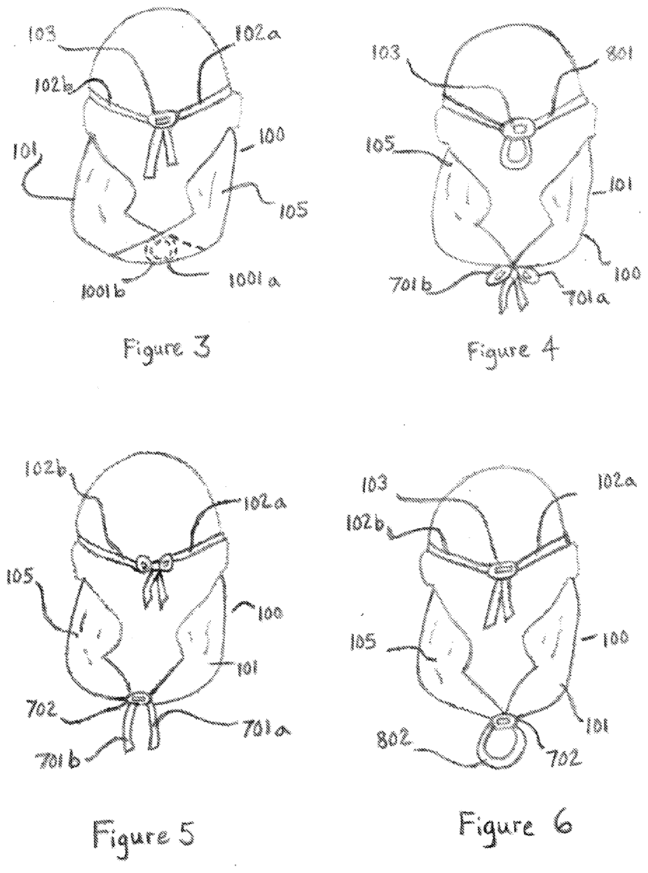

FIGS. 3, 4, 5, and 6 show the rear view of varying combinations of the top and bottom securing mechanisms of the first, second, third, and additional exemplary embodiments of a transfigurable face mask 100 worn by a mask wearer with both top and bottom securing mechanisms engaged. In FIG. 3, the straps 102a and 102b with the toggle clasp device 103 of the first embodiment comprise the top securing mechanism and magnets 1001a and 1001b of an additional embodiment comprise the bottom securing mechanism. In FIG. 4, the top securing mechanism is comprised of the single strap 801 of the third embodiment and the toggle clasp device 103 and the bottom securing mechanism is comprised of straps 701a and 701b tied at the base of a mask wearer's neck. In FIG. 5 the top securing mechanism is comprised of straps 102a and 102b tied behind a mask wearer's head at the occipital bone and the bottom securing mechanism is comprised of straps 701a and 701b and a toggle clasp devise 702. In FIG. 6 the top securing mechanism is comprised of straps 102a and 102b and a toggle clasp 103 as shown in the first embodiment and the bottom securing mechanism is comprised of a single strap 802 and toggle clasp device 702 of the third exemplary embodiment. The top and bottom securing mechanisms of the face mask device are not intended to be limited to these combinations but are intended to be combined together in any unique combination that allows and enables the face mask 100 to transition easily from and be securely and comfortably positioned by a wearer in all three of the positions made possible by the face mask design and element combination. Furthermore, although the descriptions above contain many specificities, these should not be construed as limiting the scope of the embodiments but as merely providing illustrations of some of several embodiments. Thus, the scope of the embodiments should be determined by the appended claims and their legal equivalents, rather than by the examples given.

### ADVANTAGES AND RAMIFICATIONS

From the descriptions above, a number of advantages of the embodiments of the transfigurable face mask become evident. The unique size and shape of the face mask body combined with its securing mechanisms and various elements of the embodiments produce unexpected results and provide increased versatility, comfort, and protection to a mask wearer. The size, shape, and elements of the mask body allow for it to transition easily and comfortably from position to position, provides breathability while also providing the protection of a two-mask system, reduces fogging, and conforms to all variety of face shapes and sizes. The intended placement of the mask straps and securing mechanisms at the occipital bone of the wearer unexpectedly alleviates the problem of mask slippage by disallowing the mask to be worn under the nose. Additionally, the over-the-ear strap alleviates ear discomfort. The aspects of both the top and bottom securing mechanisms also allow for a quick and convenient transition to all mask positions. These advantages provide incentives for adherence to proper mask wearing and fill a need for a new face mask design that provides aesthetically pleasing protection from viral, bacterial, environmental, or any other situation deemed applicable for face masks.

### DRAWINGS: REFERENCE NUMERALS AND KEY

100 Transfigurable Face Mask
101 Exterior and Second Layer of Mask Body
102a Right Top Strap
102b Left Top Strap
103 Toggle Clasp Device for Top Straps
104a Right Bottom Snap
104b Left Bottom Snap
105 Interior and First Layer of Mask Body
106 Nose Bridge
107 Fabric Envelope for HEPA filter insertion
701a Right Bottom Strap
701b Left Bottom Strap
702 Toggle Clasp Device for Bottom Straps
801 Top Single Continuous Strap
802 Bottom Single Continuous Strap
1001a Right Magnet
1001b Left Magnet
1101 Top of Interior Mask Body
1102 Bottom of Interior Mask Body
1103a Interior Right Side of Interior Mask Body
1103b Interior Left Side of Interior Mask Body
1201 Top of Exterior Mask Body
1202 Bottom of Exterior Mask Body
1203a Interior Right Side of Exterior Mask Body
1203b Interior Left Side of Exterior Mask Body
1301a Interior Right Mask Eye Indent
1301b Interior Left Eye Mask Indent
1302 Decorative Embellishments
1501 Top of Fabric Envelope
1502 Bottom of Fabric Envelope
1503a Right Interior Side of Fabric Envelope
1303b Left Interior Side of Fabric Envelope
1504 Traditional Stitches
1505 Serger Overlock Stitches

What is claimed is:

1. A face mask comprising: a trapezoid shaped face mask body comprised of cloth-like material and the top of said face mask body is the narrow parallel end and is of a sufficient width to extend over the nose and across the face to the helix of each ear of a wearer and has a securing mechanism attached to each of its exterior corners, the parallel sides of said face mask body are of a sufficient length to extend past the face of a wearer, and the bottom of said face mask body is the wide parallel end and is of a sufficient width to be secured at the back base of the neck of a wearer.

2. The combination of claim 1, wherein said securing mechanism of said top of face mask body is comprised of two straps.

3. The combination of claim 2, wherein said straps are attached to an additional securing devise.

4. The combination of claim 3, wherein said securing device of said straps is comprised of a toggle clasp device.

5. The combination of claim 1, wherein said securing device is comprised of a single continuous strap connected to a second securing device.

6. The combination of claim 5, wherein said second securing device is comprised of a toggle clasp device.

7. The combination of claim 1, wherein the exterior corners of said bottom of face mask body have a securing mechanism.

8. The combination of claim 7, wherein said securing mechanism of said bottom of face mask body comprises a pair of straps.

9. The combination of claim 8, wherein said straps are attached to a second securing mechanism.

10. The combination of claim 9, wherein said second securing mechanism comprises a toggle clasp device.

11. The combination of claim 7, wherein said securing mechanism of said bottom of face mask body comprises a single continuous strap and a second securing mechanism.

12. The combination of claim 11, wherein said second securing mechanism comprises a toggle clasp device.

13. The combination of claim 7, wherein said securing mechanism of said bottom of face mask body comprises a pair of snaps.

14. The combination of claim 7, wherein said securing mechanism of said bottom of face mask body comprises a pair of magnets.

15. The combination of claim 1, wherein said face mask body is comprised of a nose bridge device.

16. The combination of claim 1, wherein a fabric envelope comprised of a cloth-like, rectangular shaped body is affixed to said face mask interior layer on three of said fabric envelope sides on the area over the nose and mouth of a wearer to allow for the insertion of a HEPA filter.

17. The combination of claim 1, wherein an additional exterior layer of cloth-like material comprised of the identical dimensions of said face mask body interior is affixed to said face mask body interior to form a double-layered mask comprised of an interior layer and an exterior layer.

18. The combination of claims 16 and 17, wherein, with the addition of a HEPA filter, said face mask is comprised of four protective layers.

19. The combination of claim 1, wherein said face mask top is comprised of two oval-shaped indents to be positioned underneath each eye of a wearer.

20. The combination of claim 1, 7, 15, 18, or 19, wherein said face mask further comprises a comfortable, close-fitting, and four-layered device with securing mechanisms that can be manipulated so that said face mask may be worn in several different positions.
